(19) United States
(12) Patent Application Publication
(10) Pub. No.: US 2009/0220681 A1
(43) Pub. Date: Sep. 3, 2009

(54) Method for Production of a Multi-Layered Object

(76) Inventors: Christoph Brabec, Linz (AT); Ulrich Schindler, Furth (DE)

Correspondence Address: HOFFMANN & BARON, LLP, 6900 JERICHO TURNPIKE, SYOSSET, NY, 11791, US

(21) Appl. No.: 12/227,099

(22) PCT Filed: May 8, 2007
(86) PCT No.: PCT/EP2007/004072

§ 371 Date: Feb. 19, 2009

(30) Foreign Application Priority Data
May 9, 2006 (DE) 10 2006 021 410.2

(51) Int. Cl. B05D 5/12

(52) U.S. Cl. 427/74

(57) ABSTRACT

Described is a process for the production of a multi-layer object (10) comprising layer media which have different surface tensions and surface energies. In that respect a first layer (16) comprising a fluid first medium with a first surface tension is applied to a carrier (12) which is formed by a flexible film and applied to the first layer (16) after drying thereof is a second layer (18) comprising a fluid second medium with a second surface tension. The surface energy of the dried first layer (16) is less than the second surface tension of the fluid second medium for the second layer (18). A spreading layer (20) is applied prior to the application of the second layer (18) to the dried first layer (16).

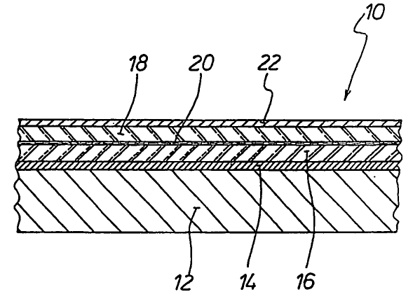

The invention concerns a process for the production of a multi-layer object comprising layer media which have different surface tensions.

By virtue of the different surface tensions and surface energies of the layer media of a multi-layer object, application of the layer media which can involve lacquers, solutions and so forth, can give rise to problems. Those problems involve wetting problems if the layer media of the multi-layer object have surface energies and surface tensions which are substantially different from each other. A multi-layer object of homogeneous layers which have the desired properties can then hitherto only be manufactured with great difficulties. Those properties can be physical properties such as electrical or electronic properties.

DE 103 06 357 A1 discloses a process for the production of a multi-layer coating, for example a multi-layer lacquering, in which there is applied to a first coating a subsequent coating material which is then hardened. In that case the first coating is selected and/or modified in such a way and/or the subsequent coating material is selected in such a way that the quotient of the surface energy of the second coating and the surface energy of the first coating is less than or equal to 1.

That known process is intended in particular for mass-production motor vehicle painting, and is substantially independent of the manufacturing conditions, the ambient temperature and the air humidity and can also be applied under extreme conditions. The first coating can be modified there for example by means of a primer.

DE 103 92 830 T5 discloses solar cells of a multi-layer configuration, which have an active layer between two electrodes such as a base electrode and a transparent electrode. The active layer has a first and a second charge transfer material. The first charge transfer material can be a conductive polymer. The second charge transfer material can be an organic material, for example a conjugate polymer.

The object of the present invention is to provide a process of the kind set forth in the opening part of this specification, in which it is possible without any problem to arrange layer media having different surface tensions and surface energies homogeneously one upon the other to implement a desired multi-layer object.

According to the invention that object is attained by the features of claim 1, that is to say in that a first layer comprising a fluid first medium with a first surface tension is applied to a carrier which is formed by a flexible film and applied to the first layer after drying thereof is a second layer comprising a fluid second medium with a second surface tension which is greater than the first surface tension, and that a spreading layer is applied prior to the application of the second layer to the dried first layer, wherein the spreading layer is a thin-film metal layer or a metal seeding or has a capillarity.

The first and second layers of the multi-layer object can also involve more than two layers.

Table 1 hereinafter specifies surface tensions of solutions given by way of example, SC (=semiconductor) and PEDOT/PSS, wherein determination of the surface tensions has been measured by means of the ‘Dynamic Contact Angle a. Tension-Meter DCAT21’ from DATA PHYSICS.

TABLE 1

| | Surface tension |
|---|---|
| Solution | (mN/m) |
| SC | 31.682 |
| PEDOT/PSS | 45.786 |

Table 2 hereinafter specifies the surface energies of PET coated with and PEDOT/PSS, wherein the surface energies have been determined by means of the ‘Optical Contact Angle Measurement Unit OCA 20’ from DATA PHYSICS.

TABLE 2

| Substrate | Surface energy |
|---|---|
| (solid state) | (total) (mN/m) |
| SC-coated film | 26.24 |
| PEDOT/PSS-coated film | 48.16 |

As can be seen from Table 2 the surface energy of PET coated with SC is of the order of magnitude of 26 mN/m and the surface energy of PET coated with PEDOT/PSS is of the order of magnitude of 48 mN/m. The corresponding fluids have a surface tension of about 32 mN/m for SC and about 46 mN/m for PEDOT/PSS. If now for example a PET film coated with PEDOT/PSS is to be coated with SC, spreading of the fluid SC medium readily occurs, that is to say good wetting of the SC on the PEDOT/PSS. If however for example a PET film coated with SC is to be coated with fluid PEDOT/PSS, the fact that the surface tension of the fluid PEDOT/PSS is greater than the surface energy of the dried SC means that no spreading of the PEDOT/PSS on the SC occurs, that is to say there is only inadequate wetting of the PEDOT/PSS on the dried SC. In order however to achieve good wetting here also, in accordance with the invention a spreading layer is applied to the dried SC layer. The spreading layer can be a thin-film metal layer. Likewise it is possible for the spreading layer to be a metal seeding which is provided on the dried first layer and the surface energy of which is less than the surface tension of the fluid second medium to be applied to the dried first layer.

The spreading layer can also have a capillarity.

The thin-film metal layer can be produced by vapour deposition, by cathode sputtering and the like. Seeding forming the spreading layer can be implemented in a per se known galvanic process.

At least one preliminary layer can be applied to the carrier formed by a flexible film prior to the application of the first layer. That at least one preliminary layer can involve an electrically conducting layer which for example forms an electrode of an electrical component such as a solar cell.

The first and second layers can comprise organic semiconductor media, as have been mentioned hereinbefore by way of example as SC and PEEDOT/PSS. If those layers comprise organic semiconductor media it is possible in accordance with the invention for example to produce polymer solar cells.

Further details, features and advantages will be apparent from the description hereinafter of an embodiment by way of example of a multi-layer object produced in accordance with the invention, of which a portion is shown in section and not true to scale.

The FIGURE shows a multi-layer object 10 with a carrier 12 which is formed by a flexible film and on which there is at least one preliminary layer 14. A first layer 16 of a fluid first medium having a first surface tension is applied to the at least one preliminary layer 14. After drying of the first layer 16, applied thereto is a second layer 18 comprising a fluid second medium having a second surface tension.

The surface energy of the dried first layer 16 is less than the second surface tension of the fluid second medium for the second layer 18 so that a spreading layer 20 is provided prior to application of the second layer 18 on the dried first layer 16. That spreading layer 20 can be a vapour-deposited or cathode-sputtered thin-film metal layer or a galvanic seeding or the like. The spreading layer 20 can have a given capillarity in order to provide for reliable wetting of the dried first layer 16 with the fluid medium for the second layer 18. A thin metal layer 22 can then be provided on the dried second layer 18, which layer 22—like the preliminary layer 14—can form an electrode of a polymer solar cell.

1. A process for the production of a multi-layer object comprising layer media which have different surface tensions and surface energies, wherein
a first layer comprising a fluid first medium with a first surface tension is applied to a carrier which is formed by a flexible film and applied to the first layer after drying thereof is a second layer comprising a fluid second medium with a second surface tension which is greater than the first surface tension, and wherein a spreading layer is applied prior to the application of the second layer to the dried first layer, wherein the spreading layer is a thin-film metal layer or a metal seeding or has a capillarity.

2. A process according to claim 1, wherein at least one pre-layer is applied to the carrier prior to the application of the first layer.

3. A process according to claim 1, wherein the first and second layers comprise organic semiconductor media.

4. Use of the process according to claim 1 for the production of polymer solar cells.
